(19) United States
(12) Patent Application Publication
(10) Pub. No.: US 2015/0287981 A1
(43) Pub. Date: Oct. 8, 2015

(54) NEGATIVE ACTIVE MATERIAL FOR RECHARGEABLE LITHIUM BATTERY, METHOD OF PREPARING SAME AND RECHARGEABLE LITHIUM BATTERY INCLUDING SAME

(71) Applicant: Samsung SDI Co., Ltd., Yongin-si (KR)

(72) Inventors: Sumihito Ishida, Yongin-si (KR); Young-Kee Kim, Yongin-si (KR); Jeong-Woo Han, Yongin-si (KR)

(21) Appl. No.: 14/597,058

(22) Filed: Jan. 14, 2015

(30) Foreign Application Priority Data
Apr. 8, 2014 (KR) 10-2014-0041970

(51) Int. Cl. H01M 4/36; H01M 4/136; H01M 4/133; H01M 10/0525; H01M 4/131

(52) U.S. Cl. CPC H01M 4/364; H01M 10/0525; H01M 4/131; H01M 4/133; H01M 4/136; H01M 2004/027

(57) ABSTRACT

A negative active material for a rechargeable lithium battery includes amorphous carbon and lithium metal nitride represented by Chemical Formula 1

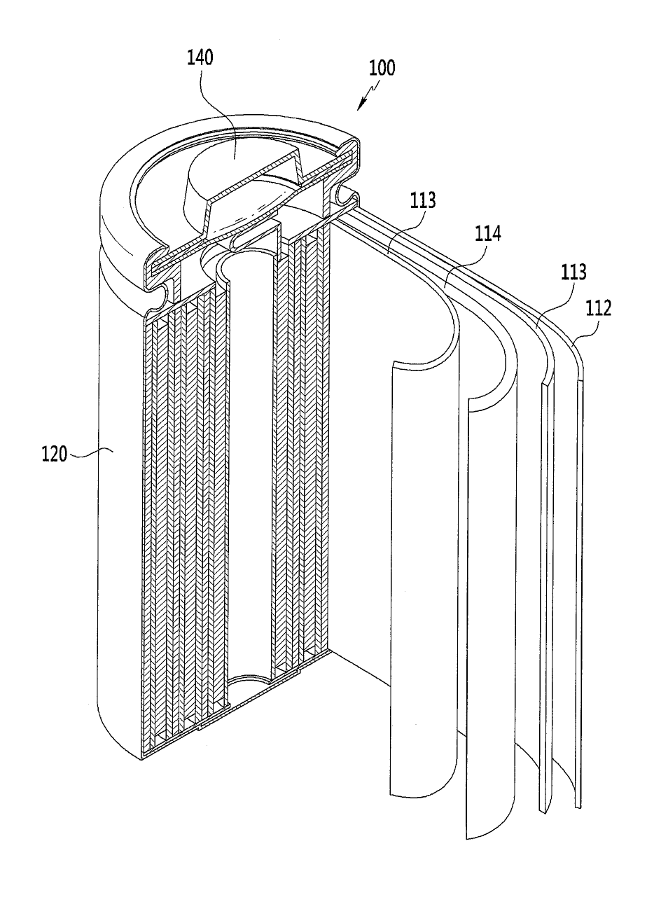

Li₃₋ₓMₓN Chemical Formula 1

In Chemical Formula 1, M and x are as described in the present disclosure. The negative active material of Chemical Formula 1 has high initial charge and discharge efficiency and excellent reversibility, as well as excellent cycle-life characteristics and high-rate charge and discharge characteristics and thus, can realize a high-capacity rechargeable lithium battery. A method of preparing the negative active material of Chemical Formula 1, and a rechargeable lithium battery including the same are also disclosed.

### CROSS-REFERENCE TO RELATED APPLICATION

This application claims priority to and the benefit of Korean Patent Application No. 10-2014-0041970 filed in the Korean Intellectual Property Office on Apr. 8, 2014, the entire content of which is incorporated herein by reference.

### BACKGROUND

1. Field

Aspects of embodiments of the present invention are directed to a negative active material for a rechargeable lithium battery, a method of preparing the same, and a rechargeable lithium battery including the same.

2. Description of the Related Art

Lithium rechargeable batteries have recently drawn attention as a power source for small portable electronic devices. The lithium rechargeable batteries use an organic electrolyte solution and thus, may have more than twice as high discharge voltage than that of a conventional battery using an alkali aqueous solution. Accordingly, lithium rechargeable batteries have high energy density.

A typical rechargeable lithium battery is manufactured by injecting an electrolyte into an electrode assembly, which includes a positive electrode including a positive active material capable of intercalating/deintercalating lithium ions and a negative electrode including a negative active material capable of intercalating/deintercalating lithium ions.

Graphite is mainly used as a negative active material, but graphite can deteriorate cycle-life characteristics of the battery, since lithium gets deposited during a high-rate charge. On the other hand, when amorphous carbon is used as a negative active material, amorphous carbon may realize good cycle-life characteristics during charge and high-rate charge. However, amorphous carbon has high irreversible capacity. Irreversible capacity refers to the capacity that cannot be utilized since part of intercalated lithium is captured inside the active material. This irreversible capacity of amorphous carbon may deteriorate the capacity of the battery, since lithium supplied to a positive active material during initial charge gets captured inside the active material and only partially returns during a later discharge.

### SUMMARY

One embodiment of the present invention provides for a negative active material useful in making a high-capacity rechargeable lithium battery that has high initial charge and discharge efficiency and excellent reversibility, as well as excellent cycle-life characteristics and high-rate charge and discharge characteristics and thus.

Another embodiment provides for a method of preparing the negative active material for a rechargeable lithium battery.

Yet another embodiment provides for a rechargeable lithium battery including the negative active material.

In one embodiment, a negative active material for a rechargeable lithium battery includes amorphous carbon and lithium metal nitride represented by the following Chemical Formula 1.

Li₃₋ₓMₓN Chemical Formula 1

In Chemical Formula 1, M is Co, Ni, Mn, Sr, Mg or Al, and 0.8<x≦2.0.

In one embodiment, x may be in the range of 1.0≦x≦1.2.

The amorphous carbon may be soft carbon, hard carbon, or a combination thereof.

The lithium metal nitride may be included in an amount of about 5 wt % to about 40 wt % based on the total amount of the amorphous carbon and the lithium metal nitride.

The negative active material may further include a silicon-based material.

In another embodiment, a method of preparing the negative active material for a rechargeable lithium battery includes obtaining lithium metal nitride represented by the above Chemical Formula 1 by mixing Li₃N and metal (M) powder and firing the mixture, and mixing the resulting lithium metal nitride with amorphous carbon to obtain the negative active material.

The firing of the mixture may be performed at a temperature of about 700° C. to about 800° C. for about 4 hours to about 8 hours.

In another embodiment, a rechargeable lithium battery includes a negative electrode including the negative active material; a positive electrode including a positive active material; and an electrolyte.

The negative electrode may further include an organic binder.

The organic binder may include polyvinylidene fluoride, polyimide, polyamideimide, polyamide, aramid, polyarylate, polyetheretherketone, polyetherimide, polyethersulfone, polysulfone, polyphenylenesulfide, polytetrafluoroethylene, or a combination thereof.

The positive active material may include a lithium-containing compound such as a lithium-containing oxide, a lithium-containing phosphate salt, a lithium-containing silicate, or a combination thereof.

The positive active material may further include activated carbon.

The activated carbon may be included in an amount of about 1 wt % to about 40 wt % based on the total amount of the lithium-containing compound and the activated carbon.

Other embodiments are included in the following detailed description.

In embodiments of the present invention, a rechargeable lithium battery having high initial charge and discharge efficiency, excellent reversibility and thus, high-capacity, and excellent cycle-life characteristics and high-rate charge and discharge characteristics may be realized.

### BRIEF DESCRIPTION OF THE DRAWING

The FIGURE is a schematic view showing a rechargeable lithium battery according to one embodiment.

### DETAILED DESCRIPTION

Hereinafter, embodiments of the present invention are described. However, these embodiments are exemplary, and this disclosure is not limited thereto. As those skilled in the art would realize, the described embodiments may be modified in various different ways, all without departing from the spirit or scope of the present invention. Accordingly, the drawings and description are to be regarded as illustrative in nature and not restrictive. Expressions such as “at least one of” and “one of,” when preceding a list of elements, modify the entire list of elements and do not modify the individual elements of the list. Further, the use of “may” when describing embodiments of the present invention refers to “one or more embodiments of the present invention.”

A negative active material for a rechargeable lithium battery according to one embodiment may include amorphous carbon and lithium metal nitride represented by the following Chemical Formula 1.

Li₃₋ₓMₓN Chemical Formula 1

In Chemical Formula 1, M is Co, Ni, Mn, Sr, Mg or Al, and x is in the range of 0.8<x≦2.0.

The amorphous carbon has good cycle-life characteristics but high irreversible capacity during charge and high-rate charge. However, this irreversible capacity of amorphous carbon may be mitigated by supplementing amorphous carbon with lithium in the lithium metal nitride, thus securing good reversibility and realizing a rechargeable lithium battery having high-capacity as well as excellent cycle-life characteristics and high-rate charge and discharge characteristics.

In one embodiment, supplementing amorphous carbon with lithium may be performed during charge and discharge of a rechargeable lithium battery. Generally, before the charge and discharge of the battery occurs, amorphous carbon has a lower potential for absorbing lithium than it does for releasing lithium initially supplied by lithium metal nitride. Accordingly, lithium does not move due to a potential difference. During the first charge, lithium is supplied from the positive electrode to the amorphous carbon of the negative electrode, but, when the charge ends, part of lithium is captured inside the active material and there is insufficient amount of lithium returning from the amorphous carbon to the positive electrode during the discharge, thus creating irreversible capacity. However, when lithium is supplied from the lithium metal nitride to the positive electrode, this irreversible capacity of the amorphous carbon may be mitigated.

In the above Chemical Formula 1, x may be in a range of 1.0≦x≦1.5, and in some embodiments 1.0≦x≦1.2. When x is within these ranges, the lithium metal nitride is stable and is safe for internal use in a rechargeable lithium battery, and accordingly, cycle-life characteristics and high-rate charge and discharge characteristics of the battery, as well as reversibility, may be improved.

The lithium metal nitride may be obtained by mixing Li₃N with a metal (M) powder and then, firing the mixture at about 700° C. to about 800° C. for about 4 hours to about 8 hours under an inert atmosphere (e.g. under a nitrogen atmosphere). Li₃N and the metal (M) powder may be mixed in appropriate mole ratios to obtain a stoichiometric ratio of the above Chemical Formula 1. In one embodiment, firing of the Li₃N and a metal (M) powder mixture may be performed at about 700° C. to about 750° C. for about 4 hours to about 7 hours.

The amorphous carbon may be soft carbon, hard carbon, or a combination thereof.

Soft carbon is graphitizable carbon and thus, can be easily graphitized as the heat treatment temperature is increased, since atoms are arranged to easily form a layered structure. In contrast, hard carbon is not developed into a graphite structure during a high temperature heat treatment.

The soft carbon may be obtained from at least one selected from coal pitch, petroleum pitch, polyvinylchloride, mesophase pitch, tar, and low molecular weight heavy oil. The hard carbon may be obtained from at least one selected from sucrose, a phenolic resin, a naphthalene resin, a polyvinyl alcohol resin, a furfuryl alcohol resin, a polyacrylonitrile resin, a polyamide resin, a furan resin, a polyimide resin, a cellulose resin, a styrene resin, an epoxy resin and chloridevinyl resin.

The lithium metal nitride may be included in an amount of about 5 wt % to about 40 wt %, and in some embodiments about 10 wt % to about 15 wt %, based on the total amount of the amorphous carbon and the lithium metal nitride. When the amorphous carbon and the lithium metal nitride are respectively used within these ranges, both the amorphous carbon and the lithium metal nitride may have excellent interaction, thus realizing good reversibility.

The negative active material may include a silicon-based material, in addition to the amorphous carbon and the lithium metal nitride.

The silicon-based material may include Si, SiOₓ (where 0<x<2), a Si—C composite, a Si—Y alloy (where Y is an element selected from an alkali metal, an alkaline-earth metal, one of Group 13 to 16 elements, a transition metal, a rare earth element, and/or a combination thereof, and Y is not Si), or a combination thereof. In one embodiment, Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof.

The silicon-based material may be included in an amount of about 1 wt % to about 50 wt %, and in some embodiments about 2 wt % to about 30 wt %, based on the total amount of the amorphous carbon, the lithium metal nitride and the silicon-based material. When the silicon-based material is included within these ranges, capacity of the battery may be further increased. In embodiments where the silicon-based material is included in the negative active material, the amorphous carbon may be included in an amount of about 10 wt % to about 94 wt %, and in some embodiments about 50 wt % to about 85 wt %, based on the total amount of the amorphous carbon, the lithium metal nitride and the silicon-based material. The lithium metal nitride may be included in an amount of about 5 wt % to about 40 wt %, and in some embodiments about 10 wt % to about 20 wt %, based on the total amount of the amorphous carbon, the lithium metal nitride and the silicon-based material.

The negative active material may be prepared by mixing the lithium metal nitride and the amorphous carbon, and in some embodiments by further adding the silicon-based material thereto. The ratio for mixing the materials for preparing the negative active material may be within the above-described ranges.

According to another embodiment, a rechargeable lithium battery including the negative active material is provided. The rechargeable lithium battery is described referring to the FIGURE. The FIGURE illustrates an example of a rechargeable lithium battery, but embodiments of the present invention are not limited thereto, and may include rechargeable lithium batteries of various shapes such as, for example, cylinder, prism, coin-type, or pouch-type.

Referring to the FIGURE, a rechargeable lithium battery 100 according to one embodiment includes an electrode assembly including a positive electrode 114, a negative electrode 112 facing the positive electrode 114, a separator 113 between the negative electrode 112 and the positive electrode 114, a battery case 120 housing the electrode assembly, and a sealing member 140 sealing the battery case 120. The electrode assembly is impregnated with an electrolyte.

In one embodiment, the negative electrode 112 includes a current collector and a negative active material layer on the current collector.

The current collector may be a copper foil, but is not limited thereto.

In one embodiment, the negative active material layer includes a negative active material, a binder, and optionally, a conductive material.

In one embodiment, the negative active material is the same as described above.

The binder improves binding properties of the negative active material particles with one another and with the current collector.

In one embodiment, since the lithium metal nitride is alkaline, the binder may be an organic binder.

The organic binder may include polyvinylidene fluoride, polyimide, polyamideimide, polyamide, aramid, polyarylate, polyetheretherketone, polyetherimide, polyethersulfone, polysulfone, polyphenylenesulfide, polytetrafluoroethylene, or a combination thereof, but the organic binder is not limited thereto.

The conductive material improves conductivity of the electrode. Any suitable electrically conductive material may be used as the conductive material, unless it causes a chemical change in the battery. Non-limiting examples of the conductive material include a carbon-based material such as natural graphite, artificial graphite, carbon black, acetylene black, ketjen black, a carbon fiber, and the like; a metal-based material of metal powder or metal fiber including copper, nickel, aluminum, silver, and the like; a conductive polymer such as a polyphenylene derivative; or a mixture thereof.

The negative electrode may be manufactured by a method that includes mixing the negative active material, the conductive material and the organic binder in an organic solvent such as N-methyl pyrrolidone to prepare a negative active material layer composition, and coating the negative active material layer composition on the current collector.

In one embodiment, the positive electrode 114 includes a current collector and a positive active material layer on the current collector. The positive active material layer includes a positive active material, a binder, and optionally, a conductive material.

The current collector may be Al (aluminum), but is not limited thereto.

The positive active material may include lithiated intercalation compounds capable of reversibly intercalating and deintercalating lithium ions.

In one embodiment, the positive active material may be a lithium-containing compound such as a lithium-containing oxide, a lithium-containing phosphate salt, a lithium-containing silicate, or a combination thereof.

The lithium-containing oxide, the lithium-containing phosphate salt and the lithium-containing silicate may respectively be an oxide, a phosphate salt and a silicate of lithium and a metal.

Non-limiting examples of the metal include Co, Ni, Mn, Fe. Cu, V, Si, Al, Sn, Pb, Sn, Ti, Sr, Mg, Ca, and the like.

Non-limiting examples of the lithium-containing oxide include lithium cobalt oxide, lithium nickel oxide, lithium manganese oxide, lithium nickel cobalt manganese oxide, lithium nickel cobalt aluminum oxide, and the like. Non-limiting examples of the lithium-containing phosphate salt include a lithium iron phosphate salt, a lithium manganese phosphate salt, a lithium iron molybdenum phosphate salt, and the like.

The positive active material may include activated carbon, in addition to the lithium-containing compound. When activated carbon is used with the lithium-containing compound, the same effect as that of a capacitor may be obtained and high output characteristics may be realized.

In one embodiment, the activated carbon is a porous carbon material that has a large surface area and thus, shows strong ion adsorption and facilitates a fast chemical reaction.

The activated carbon may be included in an amount of about 1 wt % to about 40 wt %, and in some embodiments about 1 wt % to about 15 wt %, or about 3 wt % to about 5 wt %, based on the total amount of the lithium-containing compound and the activated carbon. When the activated carbon is included within these ranges, high energy density and high output characteristics may be simultaneously secured.

The binder improves binding properties of the positive active material particles with one another and with the current collector. The binder may be made of, for example, polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like, but the binder is not limited thereto.

The conductive material improves conductivity of the electrode. Any suitable electrically conductive material may be used as the conductive material, unless it causes a chemical change in the battery. Non-limiting examples of the conductive material include one or more of natural graphite, artificial graphite, carbon black, acetylene black, ketjen black, a carbon fiber; a metal powder, a metal fiber, and the like of copper, nickel, aluminum, silver, and the like; a conductive material such as a polyphenylene derivative and the like.

The positive electrode may be manufactured by a method that includes mixing the positive active material, the conductive material, and the binder in a solvent to prepare a positive active material composition, and coating the positive active material composition on the current collector.

The electrode manufacturing method should be apparent to those of ordinary skill in the art and thus, is not described in detail in the present specification.

In one embodiment, the solvent includes N-methylpyrrolidone and the like, but is not limited thereto.

In one embodiment, the electrolyte includes a non-aqueous organic solvent and a lithium salt.

The non-aqueous organic solvent serves as a medium for transmitting ions taking part in the electrochemical reaction of the battery. The non-aqueous organic solvent may include a carbonate-based, ester-based, ether-based, ketone-based, alcohol-based, or aprotic solvent.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC) and the like.

In embodiments where linear carbonate compounds and cyclic carbonate compounds are mixed, the resulting organic solvent having a high dielectric constant and low viscosity may be realized. In one embodiment, the cyclic carbonate compound and the linear carbonate compound are mixed together in a volume ratio ranging from about 1:1 to about 1:9.

The ester-based solvent may be, for example, methylacetate, ethylacetate, n-propylacetate, dimethylacetate, methylpropionate, ethylpropionate, γ-butyrolactone, decanolide, valerolactone, mevalonolactone, caprolactone, and the like. The ether solvent may be, for example dibutylether, tetraglyme, diglyme, dimethoxyethane, 2-methyltetrahydrofuran, tetrahydrofuran, and the like, and the ketone-based solvent may be, for example, cyclohexanone, and the like. The alcohol-based solvent may be, for example, ethanol, isopropyl alcohol, and the like.

The non-aqueous organic solvent may be used singularly or in a mixture, and when the non-aqueous organic solvent is used in a mixture, the mixture ratio may be controlled in accordance with the desirable battery performance.

The non-aqueous electrolyte may further include an overcharge inhibitor additive such as, for example, ethylene carbonate, pyrocarbonate, or the like.

In one embodiment, the lithium salt dissolved in the organic solvent supplies lithium ions in the battery, improves lithium ion transportation between the positive and negative electrodes, and facilitates the basic operation of the rechargeable lithium battery.

Non-limiting examples of the lithium salt include LiPF₆, LiBF₄, LiSbF₆, LiAsF₆, LiN(SO₃C₂F₆)₂, LiC₄F₉SO₃, LiClO₄, LiAlO₂, LiAlCl₄, LiN(CₓF₂ₓ₊₁SO₂)(C_{y}F_{2y+1}SO₂), where x and y are natural numbers, e.g., an integer of 1 to 20, LiCl, LiI, LiB(C₂O₄)₂ (lithium bis(oxalato) borate; LiBOB), or a combination thereof.

The lithium salt may be used in a concentration ranging from about 0.1 M to about 2.0 M. When the lithium salt is included at the above concentration range, the electrolyte may have good performance and lithium ion mobility due to optimal electrolyte conductivity and viscosity.

The separator 113 may be made of any material suitable for use in a rechargeable lithium battery, as long as the material is capable of separating the negative electrode 112 from the positive electrode 114 and providing a transporting passage for lithium ion. In other words, the separator may have a low resistance to ion transportation and an excellent impregnation capacity for an electrolyte. For example, the separator may be made of a material selected from glass fiber, polyester, TEFLON (tetrafluoroethylene), polyethylene, polypropylene, polytetrafluoroethylene (PTFE), or a combination thereof, but the separator is not limited thereto. The separator may have a form of a non-woven fabric or a woven fabric. In one embodiment, a polyolefin-based polymer separator such as polyethylene, polypropylene or the like can be used for a lithium ion battery. In order to realize the desirable heat resistance or mechanical strength, a coated separator including a ceramic component or a polymer material may be used. In one embodiment, the coated separator may have a mono-layered or a multi-layered structure.

Hereinafter, the embodiments are illustrated with reference to examples. However, these examples are for illustrative purposes only and are not intended to limit the scope of the present invention.

Furthermore, what is not described in this disclosure may be sufficiently understood by those of ordinary skill in the art and accordingly, will not be illustrated here.

### Example 1

Hard carbon having an average particle diameter of 10 μM was obtained by curing a phenolic resin, firing it at 1500° C. under an air atmosphere for 10 hours to obtain a solid and then, grinding the solid with a ball mill.

1 mol of Li₃N was mixed with 1.18 mol of Co powder, and the mixture was fired at 700° C. under a nitrogen atmosphere for 5 hours, thus obtaining Li_{2.15}Co_{0.85}N.

The resulting hard carbon and Li_{2.15}Co_{0.85}N were mixed in a weight ratio of 9:1 to prepare a negative active material. 85 wt % of the negative active material was mixed with 10 wt % of polyvinylidene fluoride (PVDF) and 5 wt % of acetylene black, and the mixture was dispersed into N-methyl-2-pyrrolidone, thus preparing a negative active material layer composition. The negative active material layer composition was coated on a 15 μm-thick copper foil and then, dried at 100° C. and compressed, thus manufacturing a 90 μm-thick negative electrode having a density of 1.0 g/cc.

A positive active material layer composition was manufactured by mixing 85 wt % of LiCoO₂, 10 wt % of polyvinylidene fluoride (PVdF), and 5 wt % of acetylene black and dispersing the mixture into N-methyl-2-pyrrolidone. The positive active material layer composition was coated on a 15 μm-thick aluminum foil and then, dried at 100° C. and compressed, thus manufacturing a 120 μm-thick positive electrode having a density of 3.0 g/cc.

The positive and negative electrodes were spirally wound and compressed along with a 25 μm-thick polyethylene separator and placed in a 18650-sized case. An electrolyte solution was prepared by mixing ethylenecarbonate (EC) and ethylmethylcarbonate (EMC) in a volume ratio of 3:7 and dissolving LiPF₆ of 1.0 M concentration in the mixed solution. The electrolyte solution was injected into the case, thus manufacturing a rechargeable lithium battery cell.

### Example 2

Li_{1.8}Co_{1.2}N was obtained by mixing 1 mol of Li₃N and 2 mols of Co powder and firing the mixture at 700° C. under a nitrogen atmosphere for 5 hours.

A rechargeable lithium battery cell was manufactured as in Example 1 except for using the Li_{1.8}Co_{1.2}N, instead of Li_{2.15}Co_{0.85}N, to manufacture the negative electrode.

### Example 3

Li_{1.2}Co_{1.8}N was obtained by mixing 1 mol of Li₃N and 4.5 mols of Co powder and firing the mixture at 700° C. under a nitrogen atmosphere for 5 hours.

A rechargeable lithium battery cell was manufactured as in Example 1 except for using the Li_{1.2}Co_{1.8}N, instead of Li_{2.15}Co_{0.85}N, to manufacture the negative electrode.

### Example 4

LiFePO₄ was obtained by mixing Li₂CO₃, FeC₂O₄—H₂O and HN₄H₂PO₄ to manufacture a pellet and firing the resulting pellet at 600° C. for 24 hours under a nitrogen atmosphere. The resulting LiFePO₄ was ground with a ball mill to obtain 5 μm-powdered LiFePO₄ formed of 100 nm-sized primary particles.

A rechargeable lithium battery cell was manufactured as in Example 1 except for using the LiFePO₄, instead of LiCoO₂, to manufacture the positive electrode.

### Example 5

Li_{1.8}Co_{1.2}N was obtained by mixing 1 mol of Li₃N and 2 mols of Co powder and then, firing the mixture at 700° C. under a nitrogen atmosphere for 5 hours.

A rechargeable lithium battery cell was manufactured as in Example 4 except for using the Li_{1.8}Co_{1.2}N, instead of Li_{2.15}Co_{0.85}N, to manufacture the negative electrode.

### Example 6

Li_{1.2}Co_{1.8}N was obtained by mixing 1 mol of Li₃N and 4.5 mols of Co powder and firing the mixture at 700° C. under a nitrogen atmosphere for 5 hours.

A rechargeable lithium battery cell was manufactured as in Example 4 except for using the Li_{1.2}Co_{1.8}N, instead of Li_{2.15}Co_{0.85}N, to manufacture the negative electrode.

### Example 7

A rechargeable lithium battery cell was manufactured as in Example 1 except for mixing 80 wt % of LiCoO₂, 5 wt % of activated carbon, 10 wt % of polyvinylidene fluoride (PVdF) and 5 wt % of acetylene black to manufacture the positive electrode.

### Example 8

Li_{1.8}Co_{1.2}N was obtained by mixing 1 mol of Li₃N and 2 mols of Co powder and firing the mixture at 700° C. under a nitrogen atmosphere for 5 hours.

A rechargeable lithium battery was manufactured as in Example 7 except for using the Li_{1.8}Co_{1.2}N, instead of Li_{2.15}Co_{0.85}N, to manufacture the negative electrode.

### Example 9

Li_{1.2}Co_{1.8}N was obtained by mixing 1 mol of Li₃N and 4.5 mols of Co powder and firing the mixture at 700° C. under a nitrogen atmosphere for 5 hours.

A rechargeable lithium battery was manufactured as in Example 7 except for using the Li_{1.2}Co_{1.8}N, instead of Li_{2.15}Co_{0.85}N, to manufacture a negative electrode.

### Comparative Example 1

A rechargeable lithium battery was manufactured as in Example 1 except for not using any Li_{2.15}Co_{0.85}N to manufacture the negative electrode.

### Comparative Example 2

Li_{2.3}Co_{0.7}N was obtained by mixing 1 mol of Li₃N and 0.91 mol of Co powder and firing the mixture at 700° C. under a nitrogen atmosphere for 5 hours.

A rechargeable lithium battery cell was manufactured as in Example 1 except for using the Li_{2.3}Co_{0.7}N, instead of Li_{2.15}Co_{0.85}N, to manufacture the negative electrode.

### Comparative Example 3

Li_{0.7}Co_{2.3}N was obtained by mixing 1 mol of Li₃N and 9.86 mol of Co powder and firing the mixture at 700° C. under a nitrogen atmosphere for 5 hours.

A rechargeable lithium battery cell was manufactured as in Example 1 except for using the Li_{0.7}Co_{2.3}N, instead of Li_{2.15}Co_{0.85}N, to manufacture the negative electrode.

### Evaluation 1: Initial Capacity of Rechargeable Lithium Battery Cell

The rechargeable lithium battery cells according to Examples 1 to 9 and Comparative Examples 1 to 3 were current-charged with a current of 0.3 A and cut off at 4.2 V and then, current-discharged with a current of 0.3 A and cut-off at 2.0 V, and the initial capacity of each battery cell was measured. The results are provided in the following Table 1.

### Evaluation 2: High-rate Charge and Discharge Characteristics of Rechargeable Lithium Battery Cell

The rechargeable lithium battery cells according to Examples 1 to 9 and Comparative Examples 1 to 3 were charged with a current of 0.3 A and cut off at 4.2 V under a constant current and then, discharged with a current of 0.3 A and cut off at 2.0 V under a constant current, and the initial capacity of each battery cell was measured.

Subsequently, the rechargeable lithium battery cells according to Examples 1 to 9 and Comparative Examples 1 to 3 were charged with a current of 0.3 A under a constant current and cut off at 4.2 V and discharged to 2.0 V with a current of 15 A, and high-rate charge and discharge characteristics of each battery cell were evaluated, and the results are provided in the following Table 1.

Capacity retention (%) at high rate as provided in Table 1 was obtained as a percentage of capacity of a battery cell at 15 A relative to its capacity at 0.3 A.

### Evaluation 3: Cycle-Life Characteristics of Rechargeable Lithium Battery Cell

The rechargeable lithium battery cells according to Examples 1 to 9 and Comparative Examples 1 to 3 were charged with a current of 0.3 A and cut off at 4.2 V under a constant current and then, discharged with a current of 0.3 A and cut off at 2.0 V under a constant current, and the initial capacity of each battery cell was measured.

Subsequently, a cycle of charging each rechargeable lithium battery cell according to Examples 1 to 9 and Comparative Examples 1 to 3 with a current of 6 A to 4.2 V and then, discharging it with a current of 6 A to 2.0 V was repeated 1,000 times to evaluate cycle-life characteristics, and the results are provided in the following Table 1.

Capacity retention (%) depending on a cycle as provided in Table 1 was obtained as a percentage of capacity of a battery cell at 1000th cycle relative to its initial capacity.

TABLE 1

| | | Capacity | Capacity |
|---|---|---|---|
| | Initial | retention | retention |
| | capacity | at high | depending on |
| | (mAh) | rate (%) | cycle (%) |
| Example 1 | 1550 | 85 | 82 |
| Example 2 | 1490 | 87 | 84 |
| Example 3 | 1415 | 85 | 85 |
| Example 4 | 1230 | 88 | 85 |
| Example 5 | 1180 | 89 | 86 |
| Example 6 | 1120 | 88 | 88 |
| Example 7 | 1430 | 93 | 90 |
| Example 8 | 1420 | 94 | 91 |
| Example 9 | 1350 | 94 | 93 |
| Comparative Example 1 | 980 | 68 | 63 |
| Comparative Example 2 | 1580 | 82 | 54 |
| Comparative Example 3 | 1050 | 83 | 82 |

Referring to Table 1, rechargeable lithium battery cells according to Examples 1 to 9, which used a negative active material obtained by mixing amorphous carbon with lithium metal nitride represented by Chemical Formula 1, showed increased reversibility and high initial capacity and thus, better cycle-life characteristics and high-rate charge and discharge characteristics compared with the rechargeable lithium battery cells of Comparative Example 1, which used no lithium metal nitride, and Comparative Examples 2 and 3, which used lithium metal nitride having a different composition than that of the lithium metal nitride used in Examples 1 to 9.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and equivalents thereof.

What is claimed is:

1. A negative active material for a rechargeable lithium battery comprising:
amorphous carbon, and
lithium metal nitride represented by Chemical Formula 1
Li₃₋ₓMₓN Chemical Formula 1
wherein M is Co, Ni, Mn, Sr, Mg or Al, and 0.8<x≦2.0.

2. The negative active material for a rechargeable lithium battery of claim 1, wherein 1.0≦x≦1.2.

3. The negative active material for a rechargeable lithium battery of claim 1, wherein the amorphous carbon is soft carbon, hard carbon, or a combination thereof.

4. The negative active material for a rechargeable lithium battery of claim 1, wherein the lithium metal nitride is included in an amount of about 5 wt % to about 40 wt % based on the total amount of the amorphous carbon and the lithium metal nitride.

5. The negative active material for a rechargeable lithium battery of claim 1, wherein the negative active material further comprises a silicon-based material.

6. A method of manufacturing a negative active material for a rechargeable lithium battery, the method comprising:
mixing Li₃N and metal (M) powder and firing the mixture to produce lithium metal nitride represented by Chemical Formula 1
Li₃₋ₓMₓN Chemical Formula 1
wherein M is Co, Ni, Mn, Sr, Mg or Al, and 0.8<x≦2.0; and
mixing the lithium metal nitride with amorphous carbon.

7. The method of claim 6, wherein the firing of the mixture is performed at about 700° C. to about 800° C.

8. The method of claim 6, wherein the firing of the mixture is performed for about 4 hours to about 8 hours.

9. The method of claim 6, wherein the negative active material is further mixed with a silicon-based material.

10. A rechargeable lithium battery comprising
a negative electrode comprising the negative active material of claim 1;
a positive electrode comprising a positive active material; and
an electrolyte.

11. The rechargeable lithium battery of claim 10, wherein the negative electrode further comprises an organic binder.

12. The rechargeable lithium battery of claim 11, wherein the organic binder comprises polyvinylidene fluoride, polyimide, polyamideimide, polyamide, aramid, polyarylate, polyetheretherketone, polyetherimide, polyethersulfone, polysulfone, polyphenylenesulfide, polytetrafluoroethylene, or a combination thereof.

13. The rechargeable lithium battery of claim 10, wherein the positive active material comprises a lithium-containing compound comprising a lithium-containing oxide, a lithium-containing phosphate salt, a lithium-containing silicate, or a combination thereof.

14. The rechargeable lithium battery of claim 13, wherein the positive active material further comprises activated carbon.

15. The rechargeable lithium battery of claim 14, wherein the activated carbon is included in an amount of about 1 wt % to about 40 wt % based on the total amount of the lithium-containing compound and the activated carbon.
